(19) United States
(12) Patent Application Publication
(10) Pub. No.: US 2008/0156583 A1
(43) Pub. Date: Jul. 3, 2008

(54) Safety harness and method

(76) Inventor: Paul Meeks, Tallulah, LA (US)

Correspondence Address: HAYNES AND BOONE, LLP, 901 Main Street, Suite 3100, Dallas, TX, 75202, US

(21) Appl. No.: 11/646,897

(22) Filed: Dec. 28, 2006

(51) Int. Cl. A62B 35/00

(52) U.S. Cl. 182/9; 182/3

(57) ABSTRACT

A harness is described. In an exemplary embodiment, the harness is a safety harness used by, for example, a hunter when the hunter is, for example, positioned in a tree stand.

### BACKGROUND

The present disclosure relates in general to a harness, and in particular to a safety harness used by, for example, a hunter when the hunter is climbing a ladder, positioning a climbing tree stand on a tree trunk or positioned in a tree stand.

### BRIEF DESCRIPTION OF THE DRAWINGS

FIG. 1 is a perspective view of a harness according to an exemplary embodiment, with the harness being worn by a user illustrated in broken line.

FIG. 2 is another perspective view of the harness of FIG. 1.

FIG. 3A is a perspective view of a portion of the harness of FIGS. 1 and 2.

FIG. 3B is a perspective view of the portion of the harness of FIG. 3A, but depicting the portion of the harness in another configuration.

FIGS. 4A, 4B and 4C are perspective views of a user putting on the harness of FIGS. 1, 2, 3A and 3B.

FIGS. 5A, 5B and 5C are perspective views of a user positioning a climbing tree stand on a tree trunk while wearing the harness of FIGS. 1, 2, 3A and 3B.

FIGS. 6A and 6B are perspective views of a user climbing a ladder while wearing the harness of FIGS. 1, 2, 3A and 3B.

FIGS. 7A, 7B, 7C and 7D are perspective views of a user moving from the ladder of FIGS. 6A and 6B to a fixed tree stand while wearing the harness of FIGS. 1, 2, 3A and 3B.

FIGS. 8A is a perspective view of a user manipulating the portion of the harness of FIGS. 3A and 3B while being held in suspension by the harness of FIGS. 1, 2, 3A and 3B.

FIG. 8B is a perspective view of a user standing on a standing strap of the harness of FIGS. 1, 2, 3A and 3B while being held in suspension by the harness.

FIG. 8C is a perspective view of a user leaning against a seat strap of the harness of FIGS. 1, 2, 3A and 3B while being held in suspension by the harness and standing on the standing strap of the harness.

### DETAILED DESCRIPTION

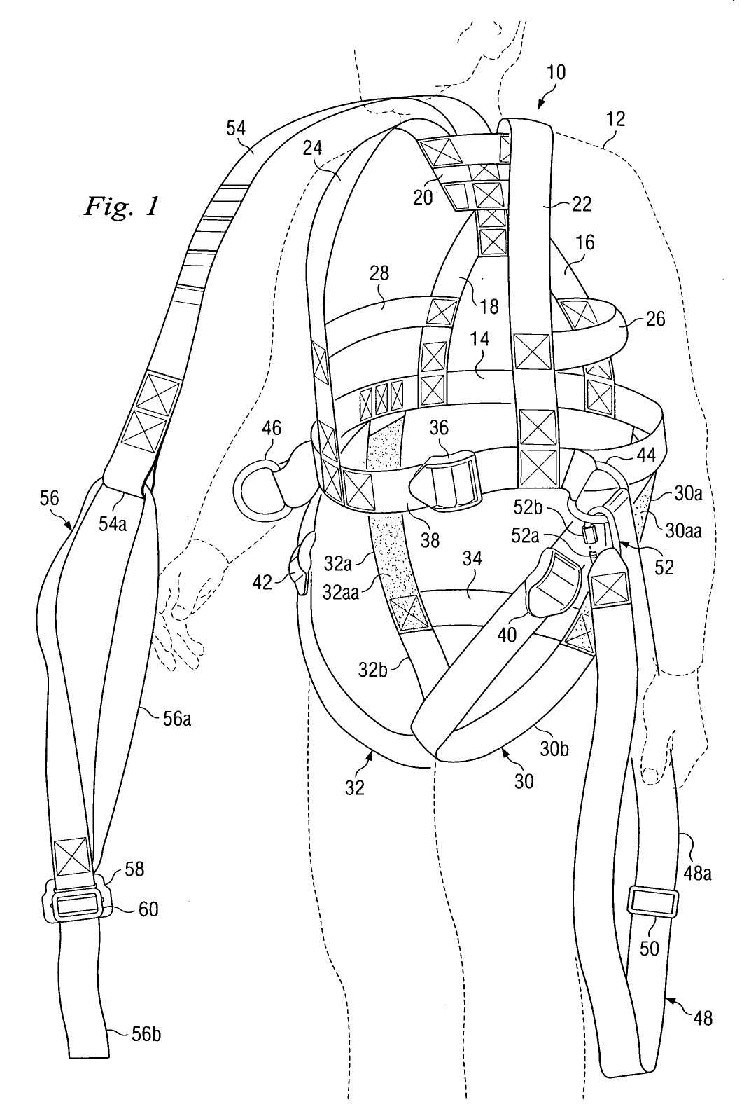

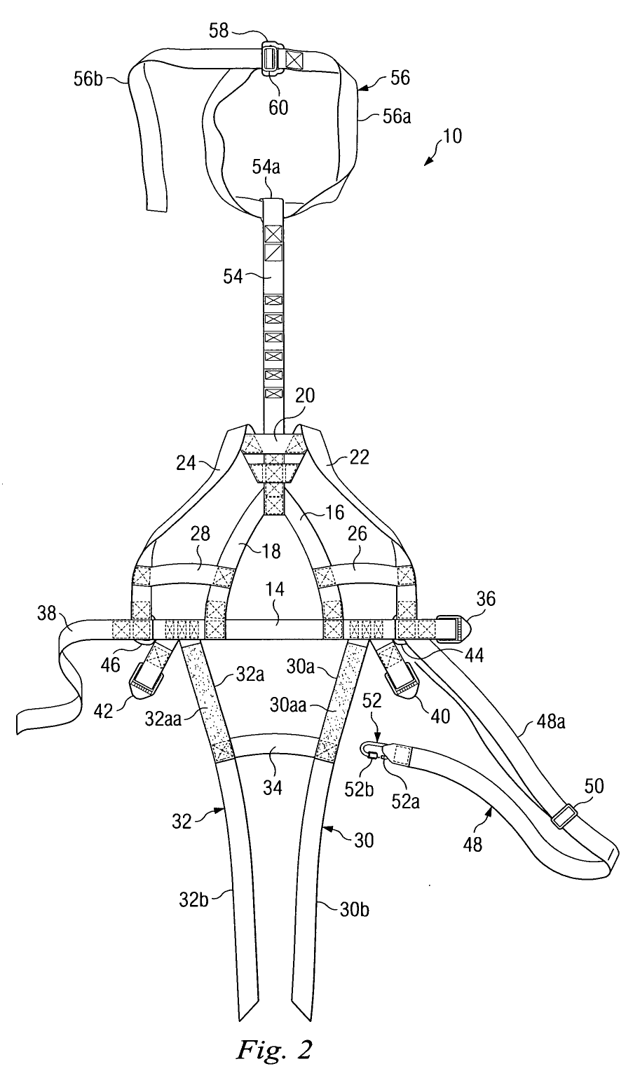

Referring to FIGS. 1 and 2, in an exemplary embodiment, a safety harness is generally referred to by the reference numeral 10 and is adapted to be worn by a user, such as a hunter 12. The harness 10 includes a waist strap 14 and back straps 16 and 18 extending upwardly therefrom and terminating at a back center portion 20.

A left shoulder strap 22 and a right shoulder strap 24 extend between the center portion 20 and respective opposing ends of the waist strap 14. A left side strap 26 extends between the left shoulder strap 22 and the back strap 16. A right side strap 28 extends between the right shoulder strap 24 and the back strap 18.

A left leg strap 30 and a right leg strap 32 extend downward from the waist strap 14, and a seat strap 34 extends between the leg straps 30 and 32. The seat strap 34 defines portions 30a and 30b of the leg strap 30, and defines portions 32a and 32b of the leg strap 32. The portions 30a and 32a of the leg straps 30 and 32, respectively, include padded liners 30aa and 32aa, respectively. A waist buckle 36 is coupled to one end of the waist strap 14, and a belt strap 38 extends from the other end of the waist strap 14 and is adapted to be removably coupled to the buckle 36 (FIG. 1), under conditions to be described below.

A left leg buckle 40 and a right leg buckle 42 are coupled to the waist strap 14. The leg straps 30 and 32 are adapted to be removably coupled to the leg buckles 40 and 42, respectively (FIG. 1), under conditions to be described below. A ring 44 is coupled to the waist strap 14 near one end thereof, and a ring 46 is coupled to the waist strap 14 near the other end thereof.

A standing strap 48 extends through the ring 44 and is thereby coupled to the waist strap 14. A buckle 50 is engaged with the standing strap 48 so that the standing strap 48 forms a loop portion 48a between the ring 44 and the buckle 50. The buckle 50 is adapted to be slidably adjusted, towards or away from the ring 44, so that the maximum inside diameter of the loop portion 48a of the standing strap 48 is adjusted and thus the overall length of the standing strap 48 is adjusted, under conditions to be described below. A ring attachment 52 is coupled to the distal end of the standing strap 48, and includes an external threaded connection 52a and an adjustable member 52b having an internal threaded connection (not shown) axially aligned therewith, which is adapted to move axially, relative to the external threaded connection 52a, and is further adapted to be removably coupled to the external threaded connection 52a to close the attachment 52, under conditions to be described below.

A tether 54 extends from the back center portion 20 and includes a loop portion 54a at its distal end. A strap 56 extends through the loop portion 54a of the tether 54. A bracket 58 is coupled to one end of the strap 56, and a bracket 60 is coupled to the strap 56. As shown in FIGS. 1 and 2, the bracket 60 is adapted to be removably coupled to the bracket 58 so that the strap 56 forms a loop portion 56a, under conditions to be described below. A distal end portion 56b of the strap 56, which opposes the end of the strap 56 that is coupled to the bracket 58, is defined by, and extends from, the bracket 60. The bracket 60 is adapted to be slidably adjusted, towards or away from the bracket 58, so that the length of the distal end portion 56b is adjusted and thus the maximum inside diameter of the loop portion 56a is adjusted, under conditions to be described below.

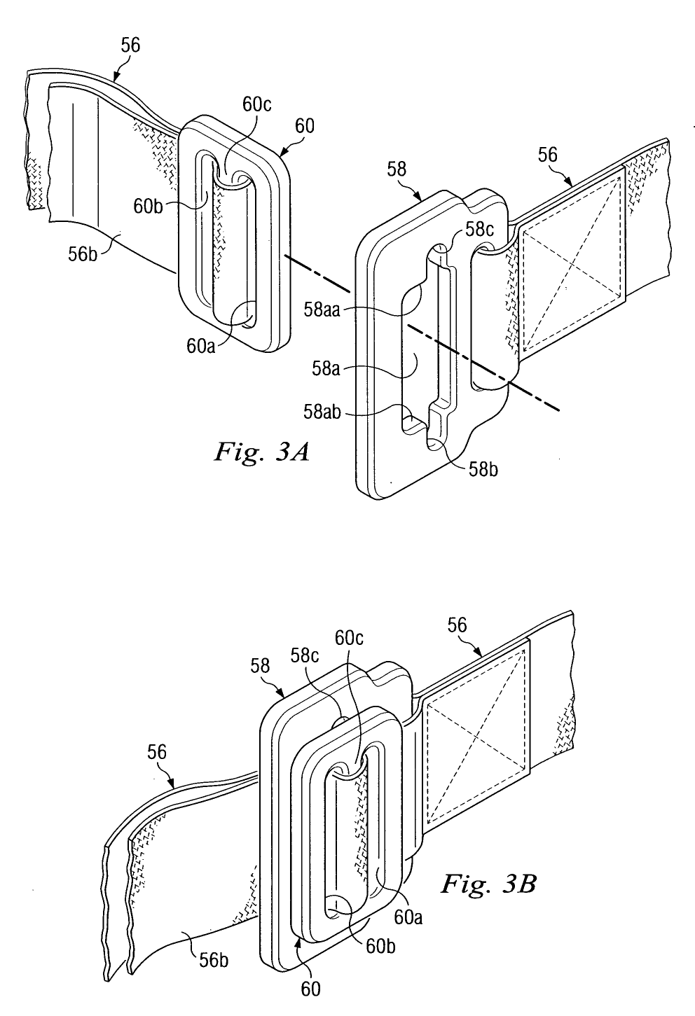

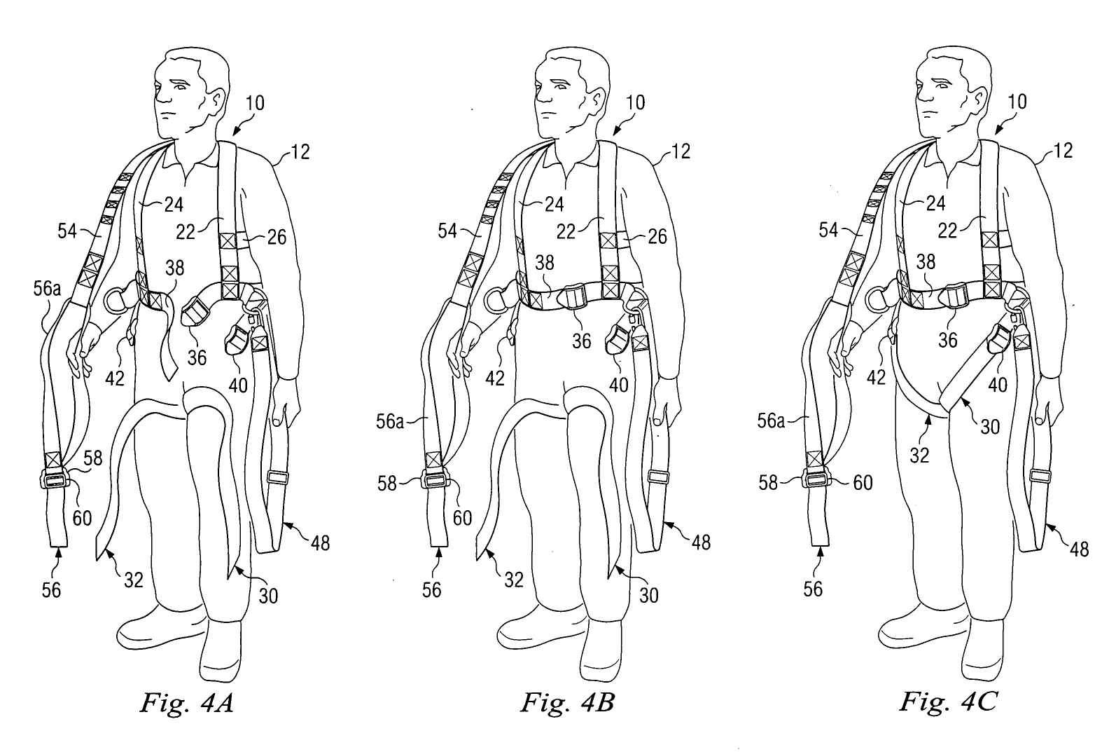

Referring to FIGS. 3A and 3B, with continuing reference to FIGS. 1 and 2, in an exemplary embodiment, the bracket 58 includes an opening 58a formed therethrough, and aligned notches 58b and 58c formed therethrough and adjacent opposing sides 58aa and 58ab of the opening 58a. The bracket 60 includes parallel-spaced slots 60a and 60b and a bar 60c extending therebetween, with the strap 56 extending through the slot 60a and then back through the slot 60b in a direction opposing the direction of extension of the strap 56 through the slot 60a. The strap 56 includes an open configuration in which the bracket 60 is not coupled to the bracket 58, as illustrated in FIG. 3A, and the loop portion 56a of the strap 56 is not formed. The strap 56 further includes a closed configuration in which the bracket 60 is coupled to the bracket 58, as illustrated in FIG. 3B, and the loop portion 56a of the strap 56 is formed.

In an exemplary embodiment, to couple the bracket 60 to the bracket 58 and thus change the configuration of the strap 56 from its open configuration illustrated in FIG. 3A to its closed configuration illustrated in FIG. 3B, the bracket 60 is inserted through the notch 58b, the opening 58a and the notch 58c of the bracket 58, as indicated by the phantom line-in FIG. 3A. During the insertion of the bracket 60 through the notch 58b, the opening 58a and the notch 58c of the bracket 58, the bracket 60 simultaneously extends within the notch 58b, the opening 58a and the notch 58c. After the insertion of the bracket 60 through the notch 58b, the opening 58a and the notch 58c of the bracket 58, the bracket 60 is rotated generally in place about the bar 60c and the strap 56 is then pulled so that the strap 56 extends through the opening 58a and the bracket 60 lays substantially flat against the bracket 58, as shown in FIG. 3B.

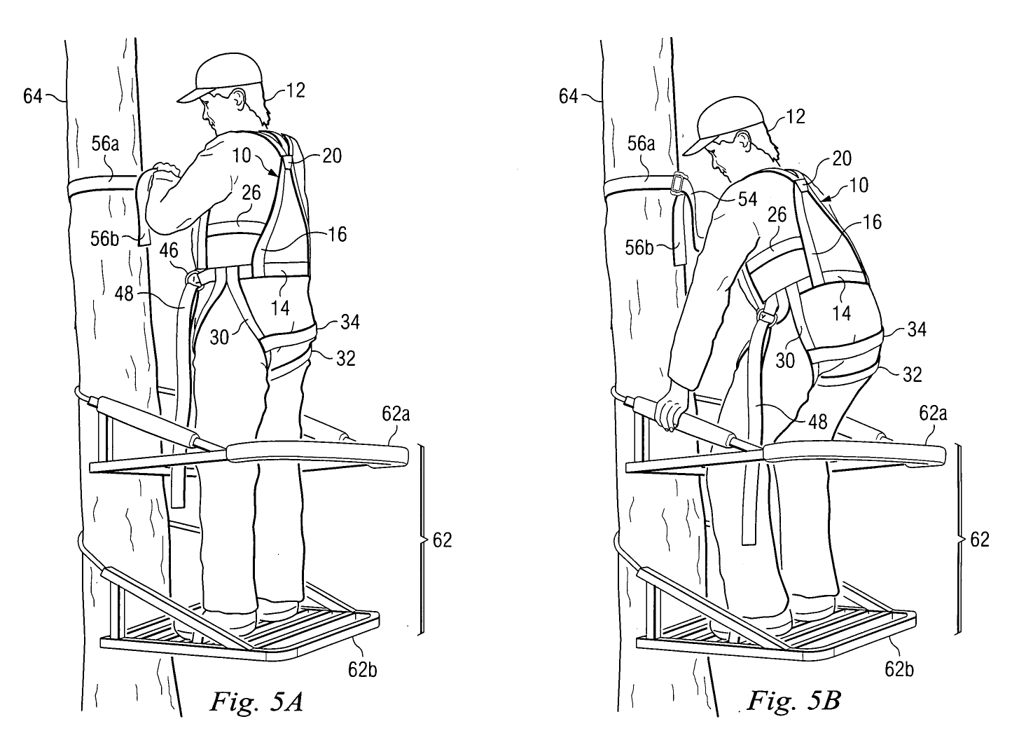

In operation, referring to FIGS. 4A, 4B and 4C with continuing reference to FIGS. 1, 2, 3A and 3B, in an exemplary embodiment, the hunter 12 dons the harness 10 so that the hunter 12 wears the harness 10. As illustrated in FIG. 4A, the left shoulder strap 22 is placed over the left shoulder of the hunter 12 so that the side strap 26 extends between the left arm and side of the hunter 12. Similarly, the right shoulder strap 24 is placed over the right shoulder of the hunter 12 so that the side strap 28 extends between the right arm and side of the hunter 12. As illustrated in FIG. 4B, the belt strap 38 is coupled to the buckle 36. As illustrated in FIG. 4C, the left leg strap 30 is coupled to the left leg buckle 40 so that the left leg strap 30 forms a loop through which the left leg of the hunter 12 extends. Similarly, the right leg strap 32 is coupled to the right leg buckle 42 so that the right leg strap forms a loop through which the right leg of the hunter 12 extends. The padded liners 30aa and 32aa of the leg straps 30 and 32, respectively, provides cushioning. As illustrated in FIGS. 4A, 4B and 4C, the standing strap 48 hangs down from the left side of the hunter 12, and the bracket 60 is coupled to the bracket 58 to form the loop 56a. After the hunter 12 dons the harness 10, the harness 10 is configured so that the hunter 12 is permitted to walk and move generally freely, almost as if the hunter 12 was not wearing the harness 10.

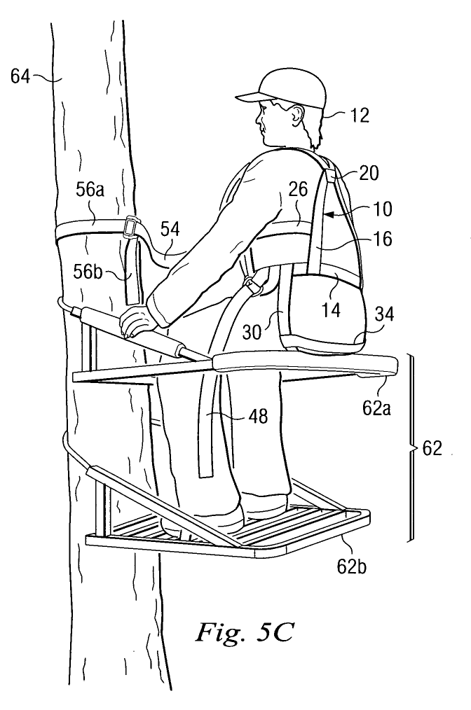

Referring to FIGS. 5A, 5B and 5C with continuing reference to FIGS. 1, 2, 3A, 3B, 4A, 4B and 4C, in an exemplary embodiment, the harness 10 is used during the positioning of a climbing tree stand 62 having an upper platform 62a and a lower platform 62b on a tree trunk 64. As illustrated in FIG. 5A, in an exemplary embodiment, the bracket 60 is uncoupled from the bracket 58, the strap 56 is disposed so that the strap 56 circumferentially extends about the tree trunk 64, and the bracket 60 is then coupled to the bracket 58, thereby forming the loop portion 56a of the strap 56. The distal end portion 56b is pulled away from the bracket 58 so that the inside diameter of the loop portion 56a is decreased and thus more closely matches the outside diameter of the tree trunk 64. As a result, the hunter 12 is coupled to the tree trunk 64 via the harness 10. The hunter 12 stands on the lower platform 62b and slides the loop 56a, and thus the tether 54, upward along the tree trunk 64 so that the loop portion 56a is positioned generally near the chest of the hunter 12 when the hunter 12 is standing. As illustrated in FIG. 5B, the climbing tree stand 62 is moved upward along the tree trunk 64 in a conventional manner using a “climbing treed stand,” as is well known in the art. As a result, and as illustrated in FIG. 5C, the climbing tree stand 62 is positioned higher and closer to the loop portion 56a of the harness 10. The loop portion 56a is then moved upward along the tree trunk 64, and the climbing tree stand 62 is again moved upward in the manner described above. The foregoing is repeated until the climbing tree stand 62 is positioned at the desired height on the tree trunk 64. At this point, the hunter is already tethered to the tree trunk 64 by the harness 10 and thus the hunter 12 is ready to look for game from the vantage point of the climbing tree stand 62. That is, once the climbing tree stand 62 is positioned on the tree trunk 64, no appreciable manipulation of the harness 10 is required in order to provide safety to the hunter 12.

In an exemplary embodiment, during the above-described positioning of the climbing tree stand 62 on the tree trunk 64, and thereafter, if the hunter 12 falls out of the climbing tree stand 62, the harness 10 catches the hunter 12, thereby preventing the hunter 12 from experiencing a complete free fall. More particularly, if the hunter 12 falls out of the climbing tree stand 62, the tether 54 stops the fall of the hunter 12, due to the hunter 12 wearing the harness 10 and the loop portion 56a circumferentially extending about the tree trunk 64.

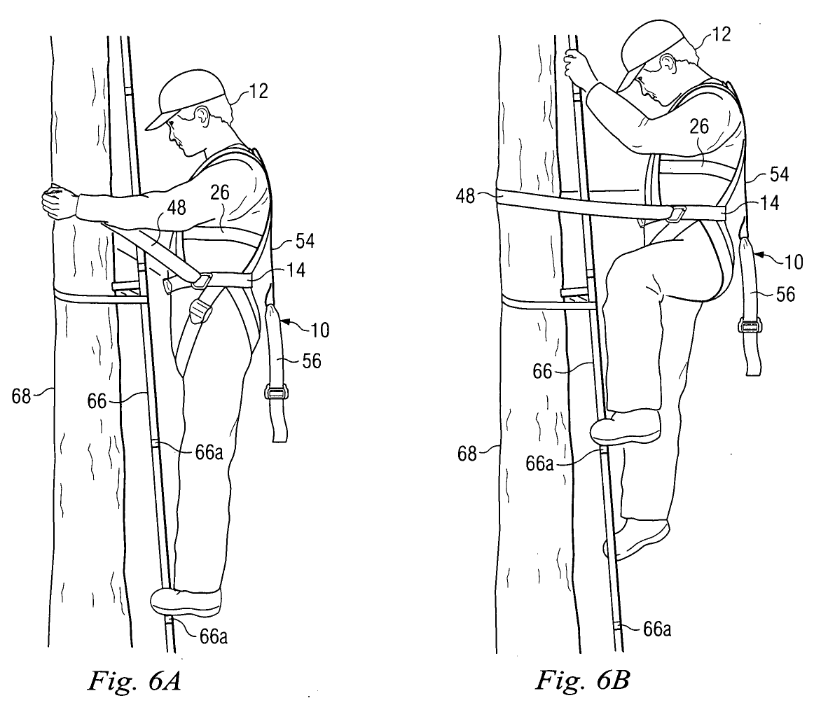

Referring to FIGS. 6A and 6B with continuing reference to FIGS. 1, 2, 3A, 3B, 4A, 4B, 4C, 5A, 5B and 5C, in an exemplary embodiment, the harness 10 is used when the hunter 12 climbs up a ladder 66 coupled to a tree trunk 68 and including a plurality of ladder rungs 66a. The attachment 52 is uncoupled from the ring 44 by rotating the adjustable member 52b about its longitudinal axis while moving the adjustable member 52b axially away from the external threaded connection 52a, thereby uncoupling the internal threaded connection in the adjustable member 52b from the external threaded connection 52a and creating an axial gap between the distal end of the external threaded connection 52a and the adjustable member 52b. This axial gap permits the attachment 52 to be uncoupled from the ring 44.

The attachment 52 is moved around the tree trunk 68 and then coupled to the ring 46, thereby positioning the standing strap 48 around the tree trunk 68. As a result, the standing strap 48 is placed in a climbing-belt configuration. The attachment 52 is coupled to the ring 46 by moving the attachment 52b towards the ring 46 so that the ring 46 passes through the axial gap between the distal end of the external threaded connection 52a and the adjustable member 52b of the attachment 52, and then rotating the adjustable member 52b while moving the adjustable member 52b axially towards the external threaded connection 52a, thereby removably coupling the internal threaded connection in the adjustable member 52b to the external threaded connection 52a.

Before, during or after the positioning of the standing strap 48 around the tree trunk 68, the buckle 50 may be slidably adjusted, towards or away from the ring 44, so that the maximum inside diameter of the loop portion 48a of the standing strap 48 is adjusted and thus the overall length of the standing strap 48 is adjusted. To increase the overall length of the standing strap 48, the buckle 50 is slid towards the ring 44. To decrease the overall length of the standing strap 48, the buckle 50 is slid away from the ring 44. As a result, the distance between the hunter 12 and the ladder 66 is adjusted.

After placing the standing strap 48 in the climbing-belt configuration, as described above, the hunter 12 climbs up the ladder 66. During the climb of the hunter 12 up the ladder 66, the standing strap 48 operates as a climbing belt, with the hunter 12 incrementally moving the standing strap 48 up the ladder 66 as the hunter 12 climbs up the ladder 66. During the climb, if the hunter 12 loses his or her footing and/or falls off of the ladder 66, the harness 10 catches the hunter 12, thereby preventing the hunter 12 from experiencing a complete free fall. More particularly, if the hunter 12 loses his or her footing and/or falls off of the ladder 66, the standing strap 48 stops the fall of the hunter 10, due to the hunter 12 wearing the harness 10 and the standing strap 48 catching against the tree trunk 68 and/or the ladder 66, thereby permitting the hunter 12 to regain his or her footing on the ladder 66.

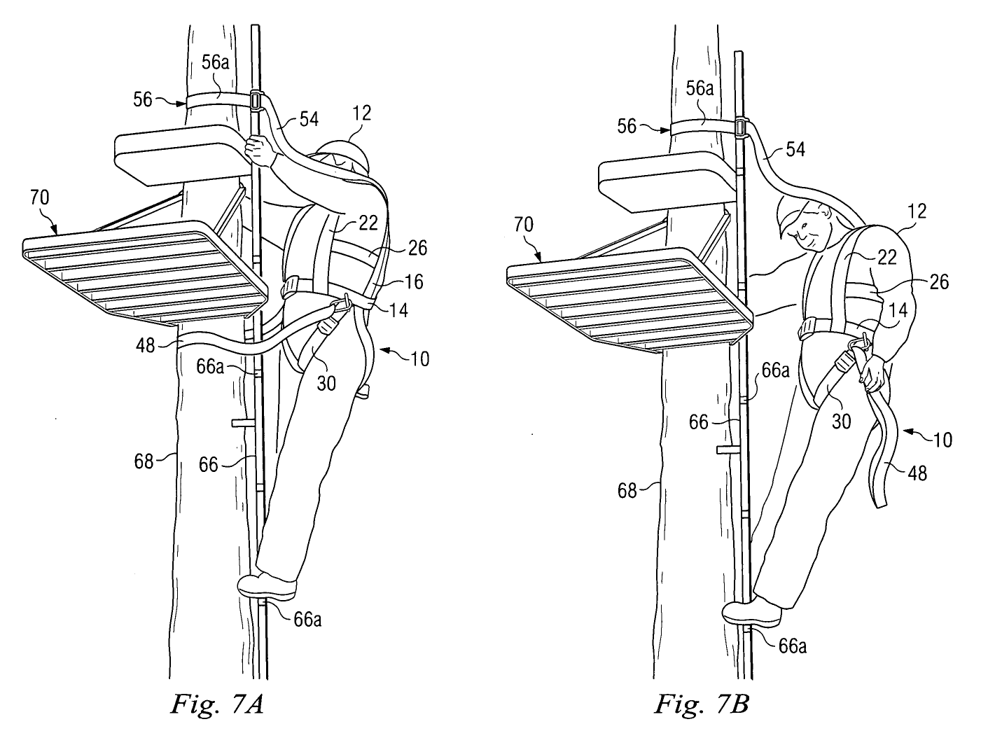

Referring to FIGS. 7A, 7B, 7C and 7D with continuing reference to FIGS. 1, 2, 3A, 3B, 4A, 4B, 4C, 5A, 5B, 5C, 6A and 6B, in an exemplary embodiment, a fixed tree stand 70 is coupled to the tree trunk 68, and the ladder 66 extends up to the vicinity of the fixed tree stand 70. After the hunter 12 has climbed up the ladder 66 and is positioned near the fixed tree stand 70, the bracket 60 is uncoupled from the bracket 58, the strap 56 is disposed so that the strap 56 circumferentially extends about the tree trunk 68, and the bracket 60 is then coupled to the bracket 58, thereby forming the loop portion 56a of the strap 56. The distal end portion 56b is pulled away from the bracket 58 so that the inside diameter of the loop portion 56a is decreased and thus more closely matches the outside diameter of the tree trunk 68. As a result, the hunter 12 is coupled to the tree trunk 68 via the loop portion 56a and the tether 54 of the harness 10. This coupling between the hunter 12 and the tree trunk 68 is effected while the hunter 12 remains coupled to the tree trunk 68 via the standing strap 48 of the harness.

After the hunter 12 is coupled to the tree trunk 68 via the loop portion 56a and the tether 54, as described above, the hunter 12 uncouples the attachment 52 from the ring 46, moves the standing strap 48 back around the tree trunk 68, and removably couples the attachment 52 to the ring 44 so that, as illustrated in FIG. 7B, the standing strap 48 once more hangs down from the left side of the hunter 12. As illustrated in FIGS. 7C and 7D, the hunter 12 then positions himself or herself in the fixed tree stand 70 and is thus ready to look for game from the vantage point of the fixed tree stand 70. Throughout the climb of the hunter 12 up the ladder 66, and the subsequent positioning of the hunter 12 in the fixed tree stand 70, the harness 10 is always coupled to the tree trunk 68, thereby providing safety to the hunter 12 at all times. If the hunter 12 falls out of the fixed tree stand 70, the harness 10 catches the hunter 12, thereby preventing the hunter 12 from experiencing a complete free fall. More particularly, if the hunter 12 falls out of the fixed tree stand 70, the tether 54 stops the fall of the hunter 10, due to the hunter 12 wearing the harness 10 and the loop portion 56a being disposed around the tree trunk 68.

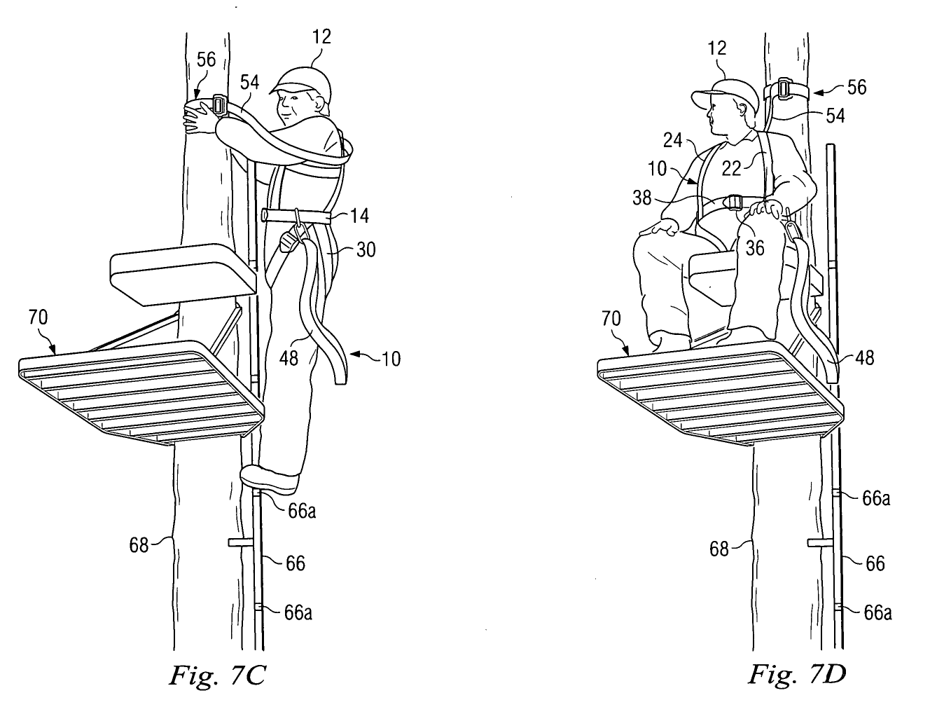

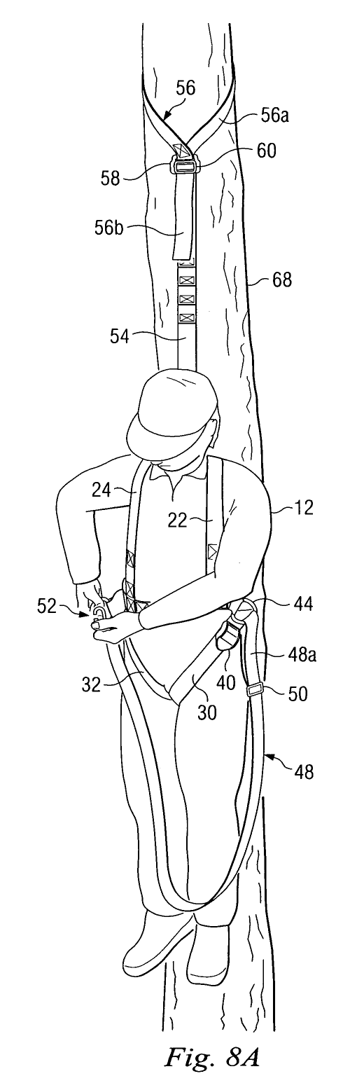

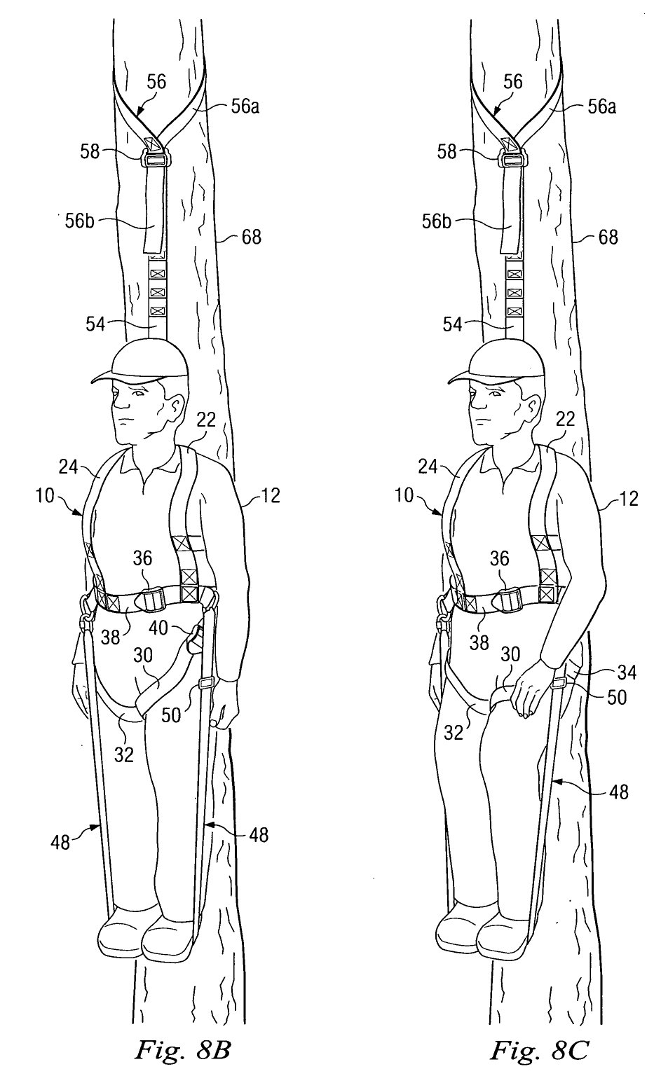

Referring to FIGS. 8A, 8B and 8C with continuing reference to FIGS. 1, 2, 3A, 3B, 4A, 4B, 4C, 5A, 5B, 5C, 6A, 6B, 7A, 7B, 7C and 7D, in an exemplary embodiment, when the hunter 12 experiences a fall from the climbing tree stand 62, the ladder 66, the fixed tree stand 70 and/or otherwise, the harness 10 catches the hunter 12, thereby preventing the hunter from experiencing a complete free fall, as described above.

More particularly, as illustrated in FIG. 8A, if the hunter falls out of, for example, the fixed tree stand 70, the tether 54 stops the fall of the hunter 10, due to the hunter 12 wearing the harness 10 and the loop portion 56a circumferentially extending about the tree trunk 68. As a result, the hunter 12 is generally suspended from the tree trunk 68 by the harness 10. Several parts of the harness 10, including the loop portion 56a of the strap 56, the tether 54, the shoulder straps 22 and 24, and the leg straps 30 and 32, are placed in tension due to the suspended weight of the hunter 12. As a result, in some cases, one or more portions of the harness 10 such as, for example, the shoulder straps 22 and 24 and the leg straps 30 and 32, have an extremely tight fit around the body of the hunter 12, applying possibly painful pressure against, for example, the arms and legs of the hunter 12.

After the harness 10 catches the fall of the hunter 12, the buckle 50 is slidably adjusted, towards or away from the ring 44, so that the maximum inside diameter of the loop portion 48a of the standing strap 48 is adjusted and thus the overall length of the standing strap 48 is adjusted. To increase the overall length of the standing strap 48, the buckle 50 is slid towards the ring 44. To decrease the overall length of the standing strap 48, the buckle 50 is slid away from the ring 44. The overall length of the standing strap 48 is adjusted until the standing strap 48 is long enough for the hunter 12 to stand up on the standing strap 48, in a manner to be described below.

As illustrated in FIG. 8A, before, during or after the adjustment of the overall length of the standing strap 48, the attachment 52 is uncoupled from the ring 44, in the manner described above, and then removably coupled to the ring 46, in the manner described above. As a result, opposing ends of the standing strap 48 are coupled to the waist strap 14 via the rings 44 and 46, respectively. Since the attachment 52 and the rings 44 and 46 are located near the hands of the hunter 12, the uncoupling of the attachment 52 from the ring 44, and the subsequent removable coupling of the attachment 52 to the ring 46, can be carried out by the hunter 12 with minimal difficulty, notwithstanding the suspension of the hunter 12 by the harness 10. After removably coupling the attachment 52 to the ring 46, the standing strap 48 is generally U-shaped.

As illustrated in FIG. 8B, the hunter 12 places his feet in the center of the U-shaped standing strap 48 and stands up, with his or her legs substantially straight. As a result, a relatively large portion of the weight of the hunter 12 is applied against the standing strap 48. Since a large portion of the weight of the hunter 12 is generally borne by the standing strap 48, the weight borne by, and thus the tension in, one or more other portions of the harness 10, such as the shoulder straps 22 and 24 and the leg straps 30 and 32, are reduced. As a result, the magnitude of any painful pressure applied against the body of the hunter 12 by the harness 10 is appreciably reduced. This general absence of appreciable discomfort facilitates the ability of the hunter 12 to wait for help for an extended period of time. While suspended by the harness 10 and standing on the standing strap 48, the hunter 12 can call for help using, for example, his or her voice, a cellular telephone and/or a two-way radio.

As illustrated in FIG. 8C, while suspended by the harness 10 and standing on the standing strap 48, the hunter 12 can sit against the seat strap 34, thereby shifting at least some of his or her weight from the standing strap 48 to the seat strap 34, thereby at least somewhat relieving the load on his or her legs. While waiting for help, the hunter 12 can shift his or her weight back and forth between, and/or at least share his or her weight between, the standing strap 48 and the seat strap 34. The ability to shift the weight of the hunter 12 while the hunter 12 is suspended by the harness 10 further facilitates the ability of the hunter 12 to wait for help for an extended period of time.

An apparatus has been described that includes a harness, the harness comprising a first portion having a first location and a second location; and a standing strap coupled to the first portion and having a first end and a second end. In an exemplary embodiment, the standing strap comprises a first configuration in which the first end of the standing strap is coupled to the first portion of the harness at the first location; the second end of the standing strap is removably coupled to the first portion of the harness at the second location; and the standing strap is arranged so that the standing strap is adapted to be stood on. In an exemplary embodiment, the standing strap further comprises a second configuration in which the first end of the standing strap is coupled to the first portion of the harness at the first location; and the second end of the standing strap is removably coupled to the first portion of the harness at the first location. In an exemplary embodiment, the standing strap further comprises a third configuration in which the first end of the standing strap is coupled to the first portion of the harness at the first location; the second end of the standing strap is removably coupled to the first portion of the harness at the second location; and the standing strap is arranged so that the standing strap is adapted to be used as a climbing belt. In an exemplary embodiment, the first portion of the harness comprises a waist strap having the first location and the second location. In an exemplary embodiment, the first portion of the harness further comprises first and second leg straps extending from the waist strap; and a seat strap extending between the first and second leg straps. In an exemplary embodiment, the first portion of the harness further comprises a center portion; and first and second shoulder straps extending between the center portion and the waist strap. In an exemplary embodiment, the first portion of the harness further comprises a tether extending from the center portion and comprising a first loop portion; and a strap extending through the first loop portion and adapted to form a second loop portion, the second loop portion adapted to circumferentially extend about a structure.

A method of operating a harness comprising a standing strap has been described that includes permitting a user to wear the harness; and if the user is held in suspension from a structure by the harness, then permitting the user to stand on the standing strap so that at least a portion of the weight of the user is generally borne by the standing strap while the user is held in suspension from the structure by the harness. In an exemplary embodiment, the tension in at least another portion of the harness is reduced in response to permitting the user to stand on the standing strap so that at least a portion of the weight of the user is generally borne by the standing strap while the user is held in suspension from the structure by the harness. In an exemplary embodiment, the harness further comprises a seat strap; and wherein the method further comprises permitting at least another portion of the weight of the user to be generally borne by the seat strap while the user is held in suspension from the structure by the harness. In an exemplary embodiment, the method comprises permitting the standing strap to hang down at the side of the user. In an exemplary embodiment, the structure comprises a tree trunk; and wherein the method further comprises permitting the user to position a climbing tree stand on the tree trunk while wearing the harness. In an exemplary embodiment, the method comprises permitting the standing strap to be used as a climbing belt. In an exemplary embodiment, the method comprises permitting the user to move along the structure while using the standing strap as a climbing belt.

A system for operating a harness comprising a standing strap has been described that includes means for permitting a user to wear the harness; and means for if the user is held in suspension from a structure by the harness, then permitting the user to stand on the standing strap so that at least a portion of the weight of the user is generally borne by the standing strap while the user is held in suspension from the structure by the harness. In an exemplary embodiment, the tension in at least another portion of the harness is reduced in response to permitting the user to stand on the standing strap so that at least a portion of the weight of the user is generally borne by the standing strap while the user is held in suspension from the structure by the harness. In an exemplary embodiment, the harness further comprises a seat strap; and wherein the system further comprises means for permitting at least another portion of the weight of the user to be generally borne by the seat strap while the user is held in suspension from the structure by the harness. In an exemplary embodiment, the system comprises means for permitting the standing strap to hang down at the side of the user. In an exemplary embodiment, the structure comprises a tree trunk; and wherein the system further comprises means for permitting the user to position a climbing tree stand on the tree trunk while wearing the harness. In an exemplary embodiment, the system comprises means for permitting the standing strap to be used as a climbing belt. In an exemplary embodiment, the system comprises means for permitting the user to move along the structure while using the standing strap as a climbing belt.

An apparatus has been described that includes a harness, the harness comprising a first portion comprising a waist strap having a first location and a second location; first and second leg straps extending from the waist strap; a seat strap extending between the first and second leg straps; a center portion; first and second shoulder straps extending between the center portion and the waist strap; a tether extending from the center portion and comprising a first loop portion; and a strap extending through the first loop portion and adapted to form a second loop portion, the second loop portion adapted to circumferentially extend about a structure; and a standing strap coupled to the first portion and having a first end and a second end, the standing strap comprising a first configuration in which the first end of the standing strap is coupled to the waist strap at the first location; the second end of the standing strap is removably coupled to the waist strap at the second location; and the standing strap is arranged so that the standing strap is adapted to be stood on; a second configuration in which the first end of the standing strap is coupled to the waist strap at the first location; and the second end of the standing strap is removably coupled to the waist strap at the first location; and a third configuration in which the first end of the standing strap is coupled to the waist strap at the first location; the second end of the standing strap is removably coupled to the waist strap at the second location; and the standing strap is arranged so that the standing strap is adapted to be used as a climbing belt.

A method of operating a harness comprising a standing strap and a seat strap has been described that includes permitting a user to wear the harness; if the user is held in suspension from a structure by the harness, then permitting the user to stand on the standing strap so that at least a portion of the weight of the user is generally borne by the standing strap while the user is held in suspension from the structure by the harness; permitting at least another portion of the weight of the user to be generally borne by the seat strap while the user is held in suspension from the structure by the harness; permitting the standing strap to hang down at the side of the user; permitting the standing strap to be used as a climbing belt; and permitting the user to move along the structure while using the standing strap as a climbing belt; wherein the tension in at least another portion of the harness is reduced in response to permitting the user to stand on the standing strap so that at least a portion of the weight of the user is generally borne by the standing strap while the user is held in suspension from the structure by the harness.

A system for operating a harness comprising a standing strap and a seat strap has been described that includes means for permitting a user to wear the harness; means for if the user is held in suspension from a structure by the harness, then permitting the user to stand on the standing strap so that at least a portion of the weight of the user is generally borne by the standing strap while the user is held in suspension from the structure by the harness; means for permitting at least another portion of the weight of the user to be generally borne by the seat strap while the user is held in suspension from the structure by the harness; means for permitting the standing strap to hang down at the side of the user; means for permitting the standing strap to be used as a climbing belt; and means for permitting the user to move along the structure while using the standing strap as a climbing belt; wherein the tension in at least another portion of the harness is reduced in response to permitting the user to stand on the standing strap so that at least a portion of the weight of the user is generally borne by the standing strap while the user is held in suspension from the structure by the harness.

It is understood that variations may be made in the foregoing without departing from the scope of the disclosure. Examples of such variations include, but are not limited to, the variations described below.

In an exemplary embodiment, the left shoulder strap 22 is marked with the term “Left Shoulder,” and the right shoulder strap 24 is marked with the term “Right Shoulder” to assist the hunter 12 when donning on the harness 10. In several exemplary embodiments, other parts of the harness 10 including, for example, the leg straps 30 and 32 are also marked with descriptive terms such as, for example, “Left Leg” and “Right Leg,” respectively.

In several exemplary embodiments, in addition to, or instead of the attachment 52, the standing strap 48 may be removably coupled to the rings 44 and/or 46 using a wide variety of other devices such as, for example, a wide variety of J-hooks, a wide variety of belay-type devices, a wide variety of carabiners, a wide variety of snap-fit attachments, a wide variety of hooks, and/or any combination thereof.

In an exemplary embodiment, when the standing strap 48 is in its climbing-belt configuration, the standing strap 48, and thus the harness 10, provides safety to the hunter 12, in the manner described above, when the hunter 12 is on the ladder 66 and is initially installing the fixed tree stand 70 on the tree trunk 68.

In several exemplary embodiments, in addition to, or instead of tree trunks, the harness 10 may be coupled to a wide variety of other structures such as, for example, commercial buildings, ladders and/or residential buildings.

In several exemplary embodiments, in addition to, or instead of tree-stand applications, the harness 10 may be used in wide variety of other applications such as, for example, window-washing applications, commercial or residential building maintenance applications, building construction applications, and/or building inspection applications.

Any spatial references such as, for example, “upper,” “lower,” “above,” “below,” “between,” “vertical,” “horizontal,” “angular,” “upward,” “downward,” “side-to-side,” “left-to-right,” “right-to-left,” “top-to-bottom,” “bottom-to-top,” “top,” “bottom,” etc., are for the purpose of illustration only and do not limit the specific orientation or location of the structure described above.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

What is claimed is:

1. Apparatus comprising a harness, the harness comprising:
a first portion having a first location and a second location; and
a standing strap coupled to the first portion and having a first end and a second end.

2. The apparatus of claim 1 wherein the standing strap comprises a first configuration in which:
the first end of the standing strap is coupled to the first portion of the harness at the first location;
the second end of the standing strap is removably coupled to the first portion of the harness at the second location; and
the standing strap is arranged so that the standing strap is adapted to be stood on.

3. The apparatus of claim 2 wherein the standing strap further comprises a second configuration in which:
the first end of the standing strap is coupled to the first portion of the harness at the first location; and
the second end of the standing strap is removably coupled to the first portion of the harness at the first location.

4. The apparatus of claim 3 wherein the standing strap further comprises a third configuration in which:
the first end of the standing strap is coupled to the first portion of the harness at the first location;
the second end of the standing strap is removably coupled to the first portion of the harness at the second location; and
the standing strap is arranged so that the standing strap is adapted to be used as a climbing belt.

5. The apparatus of claim 4 wherein the first portion of the harness comprises a waist strap having the first location and the second location.

6. The apparatus of claim 5 wherein the first portion of the harness further comprises:
first and second leg straps extending from the waist strap; and
a seat strap extending between the first and second leg straps.

7. The apparatus of claim 6 wherein the first portion of the harness further comprises:
a center portion; and
first and second shoulder straps extending between the center portion and the waist strap.

8. The apparatus of claim 7 wherein the first portion of the harness further comprises:
a tether extending from the center portion and comprising a first loop portion; and
a strap extending through the first loop portion and adapted to form a second loop portion, the second loop portion adapted to circumferentially extend about a structure.

9. A method of operating a harness comprising a standing strap, the method comprising:
permitting a user to wear the harness; and
if the user is held in suspension from a structure by the harness, then permitting the user to stand on the standing strap so that at least a portion of the weight of the user is generally borne by the standing strap while the user is held in suspension from the structure by the harness.

10. The method of claim 9 wherein the tension in at least another portion of the harness is reduced in response to permitting the user to stand on the standing strap so that at least a portion of the weight of the user is generally borne by the standing strap while the user is held in suspension from the structure by the harness.

11. The method of claim 9 wherein the harness further comprises a seat strap; and
wherein the method further comprises:
permitting at least another portion of the weight of the user to be generally borne by the seat strap while the user is held in suspension from the structure by the harness.

12. The method of claim 9 further comprising:
permitting the standing strap to hang down at the side of the user.

13. The method of claim 9 wherein the structure comprises a tree trunk; and
wherein the method further comprises:
permitting the user to position a climbing tree stand on the tree trunk while wearing the harness.

14. The method of claim 9 further comprising:
permitting the standing strap to be used as a climbing belt.

15. The method of claim 14 further comprising:
permitting the user to move along the structure while using the standing strap as a climbing belt.

16. A system for operating a harness comprising a standing strap, the system comprising:
means for permitting a user to wear the harness; and
means for if the user is held in suspension from a structure by the harness, then permitting the user to stand on the standing strap so that at least a portion of the weight of the user is generally borne by the standing strap while the user is held in suspension from the structure by the harness.

17. The system of claim 16 wherein the tension in at least another portion of the harness is reduced in response to permitting the user to stand on the standing strap so that at least a portion of the weight of the user is generally borne by the standing strap while the user is held in suspension from the structure by the harness.

18. The system of claim 16 wherein the harness further comprises a seat strap; and
wherein the system further comprises:
means for permitting at least another portion of the weight of the user to be generally borne by the seat strap while the user is held in suspension from the structure by the harness.

19. The system of claim 16 further comprising:
means for permitting the standing strap to hang down at the side of the user.

20. The system of claim 16 wherein the structure comprises a tree trunk; and
wherein the system further comprises:
means for permitting the user to position a climbing tree stand on the tree trunk while wearing the harness.

21. The system of claim 16 further comprising:
means for permitting the standing strap to be used as a climbing belt.

22. The system of claim 21 further comprising:
means for permitting the user to move along the structure while using the standing strap as a climbing belt.

23. Apparatus comprising a harness, the harness comprising:
a first portion comprising:
a waist strap having a first location and a second location;
first and second leg straps extending from the waist strap;
a seat strap extending between the first and second leg straps;
a center portion;
first and second shoulder straps extending between the center portion and the waist strap;
a tether extending from the center portion and comprising a first loop portion; and
a strap extending through the first loop portion and adapted to form a second loop portion, the second loop portion adapted to circumferentially extend about a structure; and
a standing strap coupled to the first portion and having a first end and a second end, the standing strap comprising:
a first configuration in which:
the first end of the standing strap is coupled to the waist strap at the first location;
the second end of the standing strap is removably coupled to the waist strap at the second location; and
the standing strap is arranged so that the standing strap is adapted to be stood on;
a second configuration in which:
the first end of the standing strap is coupled to the waist strap at the first location; and
the second end of the standing strap is removably coupled to the waist strap at the first location; and
a third configuration in which:
the first end of the standing strap is coupled to the waist strap at the first location;
the second end of the standing strap is removably coupled to the waist strap at the second location; and
the standing strap is arranged so that the standing strap is adapted to be used as a climbing belt.

24. A method of operating a harness comprising a standing strap and a seat strap, the method comprising:
permitting a user to wear the harness;
if the user is held in suspension from a structure by the harness, then permitting the user to stand on the standing strap so that at least a portion of the weight of the user is generally borne by the standing strap while the user is held in suspension from the structure by the harness;
permitting at least another portion of the weight of the user to be generally borne by the seat strap while the user is held in suspension from the structure by the harness;
permitting the standing strap to hang down at the side of the user;
permitting the standing strap to be used as a climbing belt; and
permitting the user to move along the structure while using the standing strap as a climbing belt;
wherein the tension in at least another portion of the harness is reduced in response to permitting the user to stand on the standing strap so that at least a portion of the weight of the user is generally borne by the standing strap while the user is held in suspension from the structure by the harness.

25. A system for operating a harness comprising a standing strap and a seat strap, the system comprising:
means for permitting a user to wear the harness;
means for if the user is held in suspension from a structure by the harness, then permitting the user to stand on the standing strap so that at least a portion of the weight of the user is generally borne by the standing strap while the user is held in suspension from the structure by the harness;
means for permitting at least another portion of the weight of the user to be generally borne by the seat strap while the user is held in suspension from the structure by the harness;
means for permitting the standing strap to hang down at the side of the user;
means for permitting the standing strap to be used as a climbing belt; and
means for permitting the user to move along the structure while using the standing strap as a climbing belt;
wherein the tension in at least another portion of the harness is reduced in response to permitting the user to stand on the standing strap so that at least a portion of the weight of the user is generally borne by the standing strap while the user is held in suspension from the structure by the harness.
